(19) United States
(12) Patent Application Publication
(10) Pub. No.: US 2010/0289770 A1
(43) Pub. Date: Nov. 18, 2010

(54) TOUCH PANEL AND TOUCH DISPLAY DEVICE

(75) Inventors: Kuo-Sheng LEE, Miao-Li County (TW); Cheng-Jen CHU, Miao-Li County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHIMEI INNOLUX CORPORATION, Miao-Li County (TW)

(21) Appl. No.: 12/775,557

(22) Filed: May 7, 2010

(30) Foreign Application Priority Data
May 13, 2009 (TW) 98115936

(51) Int. Cl. G06F 3/045; G06F 3/038

(52) U.S. Cl. 345/174; 345/205

(57) ABSTRACT

A touch panel includes a thin film transistor (TFT) substrate, a color filter (CF) substrate, at least a touch sensing electrode and at least a conductive bump. The CF substrate is disposed opposite to the TFT substrate. The touch sensing electrode is disposed on the CF substrate. The conductive bump is disposed between the TFT substrate and the CF substrate, and electrically connecting the touch sensing electrode and the TFT substrate.

### CROSS REFERENCE TO RELATED APPLICATION(S)

This non-provisional application is based on and claims priority under 35 U.S.C. §119(a) from Patent Application No. 98115936 filed in Taiwan, Republic of China on May 13, 2009, the entire content of which is hereby incorporated by reference.

### BACKGROUND

1. Technical Field

The disclosure relates to a touch panel and a touch display apparatus.

2. Related Art

With the progress of technology, various information apparatuses are created and presented to the public day by day. Among such apparatuses, keyboards and mice or other pointing devices are used to input data in the past few decades. Recently, the touch control technology has been developed and become another popular choice for data input. Moreover, owing to the recent great progress of touch sensors, touch panels using touch sensors gradually become a good tool of human-machine interface.

On the other hand, traditional data input devices, such as keyboards or mice, bring certain difficulty to the users who are not familiar to computers, and this makes an obstacle to popularization of computers. So, to provide an intuitive operating device, touch panels have been developed. The touch panel is a user-friendly input interface, so that users at any age can directly input data or select function items on a touch screen by fingers or a touch pan.

In general, a touch panel includes a display panel (e.g., an LCD panel) and a touch plate disposed on the display surface of the display panel. However, this structure of attaching the touch plate on the display panel not only increases the thickness of the touch panel but also increases the manufacturing cost. Recently, the touch plate is integrated into the display panel to save the manufacturing cost and to decrease the thickness of the touch panel.

As shown in FIG. 1, a touch panel 1 known to the inventor(s) includes a thin film transistor (TFT) substrate 101, a color filter (CF) substrate 102, a touch sensing control unit 103, a driving unit 104, a common electrode 105, an insulating layer 106, a touch sensing electrode 107, an active device 108 and a sealant 109.

The TFT substrate 101 is disposed opposite to the CF substrate 102. The driving unit 104 and the active device 108 are disposed on the TFT substrate 101. The active device 108 includes a plurality of TFTs and pixel electrodes. The driving unit 104 outputs a driving signal for driving the TFTs. The touch sensing control unit 103 and the common electrode 105 are disposed on the CF substrate 102.

In the touch panel 1, to reduce the distance from the TFT substrate 101 to the CF substrate 102 to be less than the sum of the heights of the touch sensing control unit 103 and the driving unit 104, the touch sensing control unit 103 and the driving unit 104 need to be staggered. However, the staggered touch sensing control unit 103 and driving unit 104 increase the size of the touch panel 1, contrary to the present trend of compact information apparatuses.

Besides, because the touch sensing control unit 103 and the driving unit 104 are disposed on the CF substrate 102 and the TFT substrate 101, respectively, two bonding processes of disposing the touch sensing control unit 103 on the CF substrate 102 and disposing the driving unit 104 on the TFT substrate 101 are necessary, thereby increasing the number of manufacturing processes and the manufacturing difficulty.

Therefore, there is a need to provide a touch panel and a touch display apparatus with a reduced size and a simplified manufacturing process.

### SUMMARY

In an aspect, a touch panel includes a TFT substrate, a CF substrate, at least a first touch sensing electrode and at least a first conductive bump. The CF substrate is disposed opposite to the TFT substrate. The first touch sensing electrode is disposed on the CF substrate at a side that faces the TFT substrate. The first conductive bump is disposed between the CF substrate and the TFT substrate and electrically connecting the first touch sensing electrode and the TFT substrate.

In another aspect, a touch display apparatus includes a backlight module and a touch panel. The touch panel is disposed opposite to the backlight module and includes a TFT substrate, a CF substrate, at least a first touch sensing electrode and at least a first conductive bump. The CF substrate is disposed opposite to the TFT substrate. The first touch sensing electrode is disposed on the CF substrate at a side that faces the TFT substrate. The first conductive bump is disposed between the CF substrate and the TFT substrate and electrically connecting the first touch sensing electrode and the TFT substrate.

In a further aspect, a touch display apparatus includes a first substrate and a second, transparent substrate disposed opposite to the first substrate. At least a touch sensing electrode is disposed on the second substrate. At least a conductive bump is disposed between the first and second substrates and electrically connects the touch sensing electrode and the first substrate. A touch sensing control unit is disposed on the first substrate and electrically connected with the touch sensing electrode disposed on the second substrate through the conductive bump. A driving unit is disposed on the first substrate for generating a driving signal to drive the touch display apparatus to display an image viewable through the second, transparent substrate.

### BRIEF DESCRIPTION OF THE DRAWINGS

Exemplary embodiments of the invention will be described in the following detailed description with reference to the accompanying drawings, which are given for illustration only, and thus are not limitative of the present invention, wherein the same references relate to the same elements and wherein:

FIG. 1 is a schematic diagram of a known touch display apparatus;

FIGS. 2A to 2G are schematic diagrams showing various aspects of a touch panel in accordance with one or more embodiments of the invention; and

FIG. 3 is a schematic diagram of a touch display apparatus in accordance with one or more embodiments of the invention.

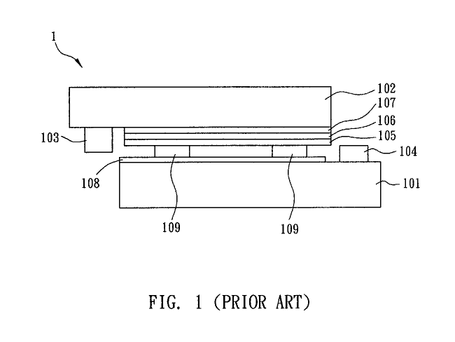

### DETAILED DESCRIPTION

Touch panel technology can be divided into a resistive type, a capacitive type, a surface acoustic wave type and an optics type based on sensing principles, and hereinafter, the capacitive type, which is more widely applied in the touch panel and touch display apparatus, will be described for example. The present invention, however, is not limited to the capacitive type of touch panel technology, and covers any and all other types of touch panel technology including those listed above.

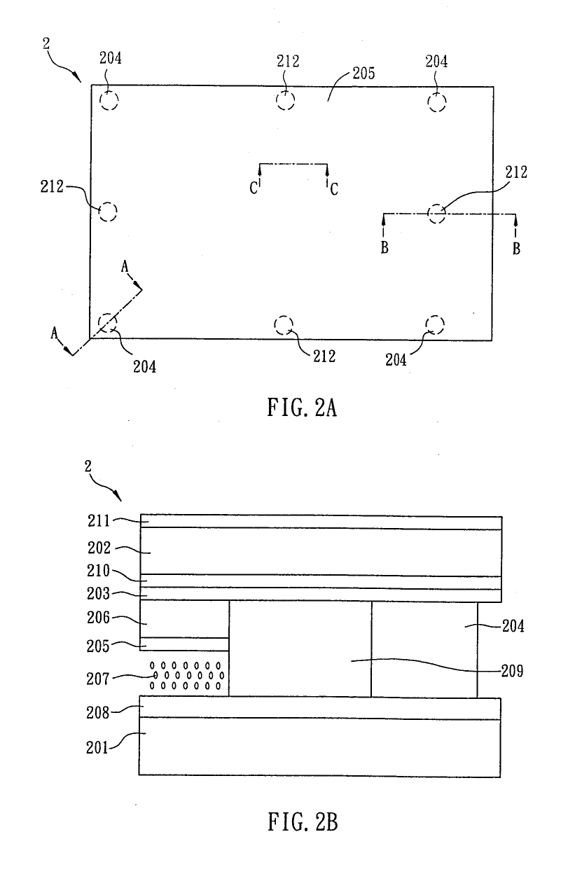

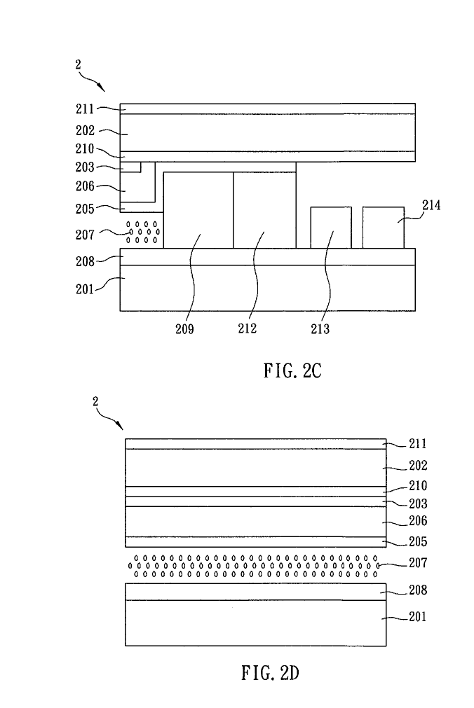

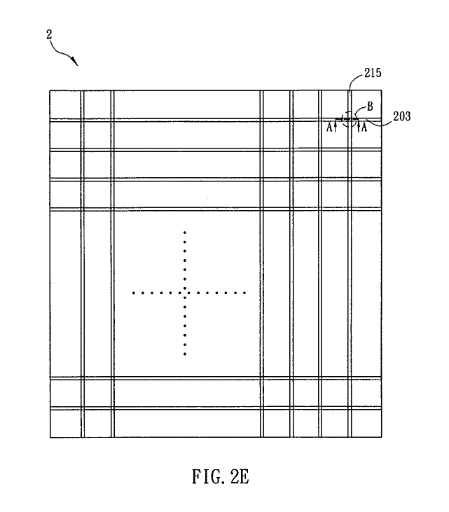

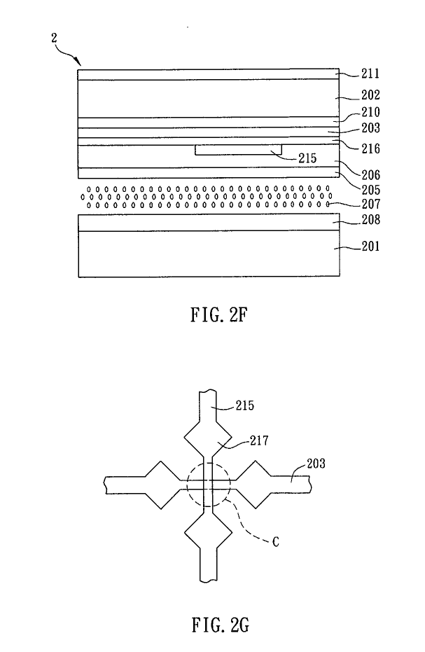

FIG. 2A is a top view of a touch panel 2 in accordance with one or more embodiments of the invention, and FIG. 2B is a cross-sectional diagram taken along the section line A-A in FIG. 2A. As shown in FIGS. 2A and 2B, the touch panel 2 includes a TFT substrate 201, a CF substrate 202, at least a first touch sensing electrode 203, at least a first conductive bump 204 and a common electrode 205.

The TFT substrate 201 is disposed opposite to the CF substrate 202. In various embodiments, the TFT substrate 201 and/or the CF substrate 202 is/are made of various materials according to the actual demands, for example, glass or plastic.

The first touch sensing electrode 203 and the common electrode 205 are disposed on the CF substrate 202, at the side that faces the TFT substrate 201. The first conductive bump 204 is disposed between the CF substrate 202 and the TFT substrate 201, and is electrically connected with the first touch sensing electrode 203 and the TFT substrate 201. The material of the first conductive bump 204 in some embodiments includes at least one of gold, tin, copper, and alloys thereof. In further embodiments, the first conductive bump 204 is made of other conductive materials. In an exemplary embodiment, the first conductive bump 204 is formed by adding and mixing conductive gold balls into adhesive.

Referring to FIG. 2B, the touch panel 2 further includes a color filter layer (e.g., a photoresist layer) 206, a liquid crystal layer 207, a pixel electrode 208, a sealant 209, a black matrix (BM) 210 and a polarizing plate 211.

The photoresist layer 206 is disposed between the first touch sensing electrode 203 and the common electrode 205. The pixel electrode 208 is disposed on the TFT substrate 201, at the side that faces the CF substrate 202. The liquid crystal layer 207 is disposed between the common electrode 205 and the pixel electrode 208. The photoresist layer 206 functions as color filters and includes a red photoresist, a green photoresist, a blue photoresist, a planarization photoresist, or any of their combinations. Color filter materials other than photoresist are within the scope of the invention.

The sealant 209 is disposed between the TFT substrate 201 and the CF substrate 202 for preventing the liquid crystal layer 207 from leaking out. The BM 210 is disposed between the CF substrate 202 and the first touch sensing electrode 203 for shielding the non-display area. The polarizing plate 211 is disposed on the CF substrate 202, at the side that faces away from the TFT substrate 201. In some embodiments, the BM 210 is integrated with the photoresist layer 206, for example.

FIG. 2C is a cross-sectional diagram taken along the section line B-B in FIG. 2A. As shown in FIG. 2C, the touch panel 2 further includes at least a second conductive bump 212 that is disposed between the TFT substrate 201 and the CF substrate 202. The second conductive bump 212 is electrically connected with the common electrode 205 and the pixel electrode 208 for example. The material of the second conductive bump 212 in some embodiments includes at least one of gold, tin, copper, alloys thereof, and their combinations. In further embodiments, the second conductive bump 212 is made of other conductive materials. In an exemplary embodiment, the second conductive bump 212 is formed by adding and mixing conductive gold balls into adhesive. The pixel electrode 208 is extended to electrically connect to a conductive pattern such as the signal lines on the circuit board (e.g. the TFT substrate 201).

Besides, the touch panel 2 further includes a driving unit 213 and a touch sensing control unit 214, both of which are electrically connected with the conductive pattern for transmitting signals. When someone touches the touch panel 2, the first touch sensing electrode 203 generates signals, which are transmitted to the TFT substrate 201 through the first conductive bump 204 and the second conductive bump 212, and then transmitted to the touch sensing control unit 214 through the proper conductive pattern.

The driving unit 213 and the touch sensing control unit 214 are disposed on the TFT substrate 201. The driving unit 213 generates a driving signal to drive at least one thin film transistor of the TFT substrate 201. In some embodiments, the driving unit 213 and the touch sensing control unit 214 include separate chips or integrated circuits (ICs). In further embodiments, the driving unit 213 and the touch sensing control unit 214 are integrated to the same chip or IC.

Without a human body part touching the touch panel 2, the whole first touch sensing electrode 203 is equipotential and no current occurs on the first touch sensing electrode 203. When a human body part, which always carries electric charges, touches the touch panel 2, the static electricity in the human body part is grounded through the touch panel 2 and a weak current is generated and passes through the first touch sensing electrode 203. Meanwhile, the touch sensing control unit 214 receives the sensing signal from the first touch sensing electrode 203 through the first conductive bump 204 and the TFT substrate 201, and determines the touch location according to the variation of electric charges on the first touch sensing electrode 203.

FIG. 2D is a cross-sectional diagram taken along the section line C-C in FIG. 2A. As shown in FIGS. 2C and 2D, the photoresist layer 206 is disposed between the first touch sensing electrode 203 and the common electrode 205.

The touch panel 2 is configured in some embodiments to have a single piece of the touch sensing electrode as mentioned above. In further embodiments, it is configured to have the touch sensing electrodes staggered. FIG. 2E is a schematic top view of the touch panel 2 in accordance with some embodiments in which the first touch sensing electrode 203 and a second touch sensing electrode 215 intersect each other.

FIG. 2F is a schematic cross-sectional view taken along the section line A-A in FIG. 2E. As shown in FIG. 2F, the touch panel 2 further includes at least a second touch sensing electrode 215 and an insulating layer 216. The second touch sensing electrode 215 is disposed opposite to the first touch sensing electrode 203, and the insulating layer 216 is disposed between the touch sensing electrodes 203 and 215. FIG. 2G is a schematic top view showing an enlargement of the area B in FIG. 2E with reference to the touch sensing electrodes 203, 215. As shown in FIG. 2G, there is an overlap between a portion of the first touch sensing electrode 203 and a portion of the second touch sensing electrode 215 in the thickness direction of the touch panel. Outside the overlap portion, the other portions of the first touch sensing electrode 203 and/or the second touch sensing electrode 215 have an enlarged geometrical pattern 217. The geometrical pattern 217 in some embodiments is a quadrilateral, a triangle, a circle or a polygon although other shapes are also within the scope of the invention. Herein for instance, the geometrical pattern 217 is a quadrilateral as exemplarily illustrated in FIG. 2G.

Referring to FIGS. 2F and 2G, the first touch sensing electrode 203 and the second touch sensing electrode 215 form a capacitance at their overlap portion. The larger the overlap portion, the larger the capacitance will be; and, on the contrary, the smaller the overlap portion, the smaller the capacitance will be.

In the case of the touch sensing electrodes intersecting with each other, the gap between the touch sensing electrodes 203, 215 will change when the touch panel is touched, and this leads to a resistance-capacitance delay (RC delay) by which the touch sensing control unit 214 can determine which point is touched.

To be noted, the first touch sensing electrode 203 and/or the second touch sensing electrode 215 has a narrow width in the area C (FIG. 2G), and the first touch sensing electrode 203 and/or the second touch sensing electrode 215 has a larger width at the far end of the geometrical pattern 217 from the area C, so that the overlap portion of the first touch sensing electrode 203 and the second touch sensing electrode 215 can be reduced in size. Therefore, the touch panel 2 has a reduced capacitance and thus an increased area for touch sensing of the first touch sensing electrode 203 and the second touch sensing electrode 215.

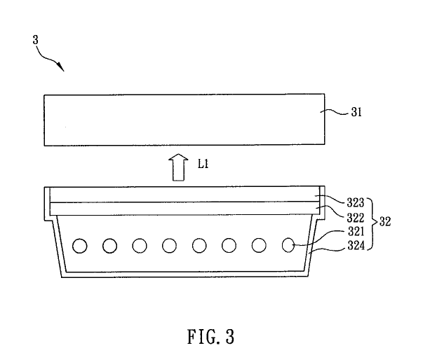

As shown in FIG. 3, a touch display apparatus 3 according to one or more embodiments of the invention includes a touch panel 31 and a backlight module 32.

In general, the backlight module 32 is a direct type or a side-edge type according to the arrangement of the light source(s). The backlight module 32 of the embodiment specifically illustrated in FIG. 3 is of the direct type, for example. The backlight module 32 includes one or more light sources 321, a diffusing plate 322, at least a set of optical films 323 and a frame 324.

The light source 321 generates light rays L1 that pass through the diffusing plate 322 and the set of optical films 323 sequentially to turn into well mixed light rays, which then reach the touch panel 31.

Because the touch panel 31 has the features of the touch panel 2 as mentioned in the above embodiments, detailed descriptions are omitted here.

In summary, for the touch panel and the touch display apparatus according to embodiments of the invention, a sensing signal of the first touch sensing electrode is transmitted to the TFT substrate through at least the first conductive bump, and then transmitted to the touch sensing control unit. In comparison with the known arrangement, the driving unit and the touch sensing control unit can be disposed on the same substrate, and can be even integrated to the same IC, thereby reducing the height as well as the size of the touch panel and the touch display apparatus, and simplifying the manufacturing process thereof.

It should be noted that while the exemplary embodiments specifically disclosed herein include LCD displays, it is within the scope of the present invention to provide embodiments that use other types of display device including, but not limited to, plasma displays, organic light emitting diode displays (OLEDs), electroluminescent displays (ELDs) etc. Likewise, while the exemplary embodiments specifically disclosed herein include backlight modules, it is within the scope of the present invention to provide embodiments that do not need a backlight modules depending on the display technology being used, e.g., OLED or ELD, etc.

Although specific embodiments have been described, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A touch panel, comprising:
a thin film transistor (TFT) substrate;
a color filter (CF) substrate disposed opposite to the TFT substrate;
at least a first touch sensing electrode disposed on the CF substrate at a side that faces the TFT substrate; and
at least a first conductive bump disposed between the CF substrate and the TFT substrate and electrically connecting the first touch sensing electrode and the TFT substrate.

2. The touch panel as recited in claim 1, further comprising:
a common electrode disposed on the CF substrate at the side that faces the TFT substrate; and
a color filter layer disposed between the common electrode and the CF substrate.

3. The touch panel as recited in claim 1, further comprising:
at least a second touch sensing electrode disposed opposite to the first touch sensing electrode; and
an insulating layer disposed between the first touch sensing electrode and the second touch sensing electrode.

4. The touch panel as recited in claim 3, wherein a portion of the first touch sensing electrode overlaps a portion of the second touch sensing electrode in a thickness direction of the touch panel.

5. The touch panel as recited in claim 4, wherein a portion of the first or second touch sensing electrode which does not overlap the second or first touch sensing electrode has an enlarged geometrical pattern.

6. The touch panel as recited in claim 4, wherein the overlapping portions of the first and second touch sensing electrodes have a width smaller than portions where the first and second touch sensing electrodes do not overlap.

7. The touch panel as recited in claim 2, further comprising:
at least a second conductive bump disposed between the CF substrate and the TFT substrate and electrically connecting the common electrode and the TFT substrate.

8. The touch panel as recited in claim 1, further comprising:
a touch sensing control unit disposed on the TFT substrate and electrically connected with the first touch sensing electrode disposed on the CF substrate through the first conductive bump.

9. The touch panel as recited in claim 8, further comprising:
at least one TFT on the TFT substrate; and
a driving unit on the TFT substrate for generating a driving signal to drive said at least one TFT.

10. The touch panel as recited in claim 9, wherein the touch sensing control unit and the driving unit are integrated in a single chip.

11. A touch display apparatus, comprising:
a backlight module; and
a touch panel disposed opposite to the backlight module and having
a thin film transistor (TFT) substrate,
a color filter (CF) substrate disposed opposite to the TFT substrate,
at least a first touch sensing electrode disposed on the CF substrate at a side that faces the TFT substrate, and
at least a first conductive bump disposed between the CF substrate and the TFT substrate and electrically connecting the first touch sensing electrode and the TFT substrate.

12. The touch display apparatus as recited in claim 11, wherein the touch panel further comprises:
a common electrode disposed on the CF substrate at the side that faces the TFT substrate; and
a color filter layer disposed between the common electrode and the CF substrate.

13. The touch display apparatus as recited in claim 12, wherein the touch panel further comprises:
at least a second touch sensing electrode disposed opposite to the first touch sensing electrode; and
an insulating layer disposed between the first touch sensing electrode and the second touch sensing electrode;
wherein a portion of the first touch sensing electrode overlaps a portion of the second touch sensing electrode in a thickness direction of the touch panel.

14. The touch display apparatus as recited in claim 13, wherein a portion of the first or second touch sensing electrode which does not overlap the second or first touch sensing electrode has an enlarged geometrical pattern.

15. The touch display apparatus as recited in claim 13, wherein the overlapping portions of the first and second touch sensing electrodes have a width smaller than portions where the first and second touch sensing electrodes do not overlap.

16. The touch display apparatus as recited in claim 12, wherein the touch panel further comprises:
at least a second conductive bump disposed between the CF substrate and the TFT substrate and electrically connecting the common electrode and the TFT substrate.

17. The touch display apparatus as recited in claim 12, wherein the touch panel further comprises:
a pixel electrode disposed on the TFT substrate at the side that faces the CF substrate; and
a liquid crystal layer disposed between the common electrode and the pixel electrode.

18. The touch display apparatus as recited in claim 11, wherein the touch panel further comprises:
a touch sensing control unit disposed on the TFT substrate and electrically connected with the first touch sensing electrode disposed on the CF substrate through the first conductive bump;
at least one TFT on the TFT substrate; and
a driving unit on the TFT substrate for generating a driving signal to drive said at least one TFT.

19. The touch display apparatus as recited in claim 18, wherein the touch sensing control unit and the driving unit are integrated in a single chip.

20. A touch display apparatus, comprising:
a first substrate;
a second, transparent substrate disposed opposite to the first substrate;
at least a touch sensing electrode disposed on the second substrate;
at least a conductive bump disposed between the first and second substrates and electrically connecting the touch sensing electrode and the first substrate;
a touch sensing control unit disposed on the first substrate and electrically connected with the touch sensing electrode disposed on the second substrate through the conductive bump; and
a driving unit disposed on the first substrate for generating a driving signal to drive said touch display apparatus to display an image viewable through the second, transparent substrate.
